(19) United States
(12) Patent Application Publication
(10) Pub. No.: US 2004/0169805 A1
(43) Pub. Date: Sep. 2, 2004

(54) Apparatus for forming alignment film of liquid crystal display device and method for forming alignment film using the same

(75) Inventors: Heon-Do Yun, Daegu (KR); Yong-Sang Byun, Gumi (KR)

Correspondence Address: MORGAN LEWIS & BOCKIUS LLP, 1111 PENNSYLVANIA AVENUE NW, WASHINGTON, DC, 20004, US

(73) Assignee: LG. Philips LCD Co., Ltd.

(21) Appl. No.: 10/787,966

(22) Filed: Feb. 27, 2004

(30) Foreign Application Priority Data
Feb. 27, 2003 (KR) 12466/2003

(51) Int. Cl. G02F 1/1337

(52) U.S. Cl. 349/124

(57) ABSTRACT

A method for forming an alignment layer of a liquid crystal display device includes: providing a substrate with a unit panel area; loading the substrate on a stage; selectively dropping an alignment material onto the unit panel area through an alignment material dropping unit having a head that has a plurality of holes through which the alignment material is dropped; and removing alignment material remaining about the holes of the alignment material dropping unit by an alignment material removing unit which scrapes the surface of the alignment material dropping unit having the holes therein.

The present invention claims the benefit of Korean Patent Application No. 2003-12466 filed in Korea on Feb. 27, 2003, which is hereby incorporated by reference.

### BACKGROUND OF THE INVENTION

1. Field of the Invention

The present invention relates to an alignment film of a liquid crystal display device, and more particularly, to an apparatus for forming an alignment layer of a liquid crystal display device and method for forming an alignment layer.

2. Description of the Related Art

Because of the recent developments in various portable electronic devices, such as mobile phones, PDAs and notebook computers, the demand for a light, thin, small flat panel display device is increasing. Research is actively ongoing on several types of flat panel display devices including LCD (Liquid Crystal Display), PDP (Plasma Display Panel), FED (Field Emission Display), VFD (Vacuum Fluorescent Display) and other technologies. Of the aforementioned flat panel display devices, the LCD has received much attention because it is simple to mass produce and can be easily used with a driving system that implements a high quality picture.

FIG. 1 shows a cross-section of a related art liquid crystal display device. As shown in FIG. 1, a liquid crystal display device 1 includes a lower substrate 5, an upper substrate 3 and a liquid crystal layer 7 formed between the lower substrate 5 and the upper substrate 3. The lower substrate 5 is a driving unit array substrate that includes a plurality of pixels (not shown). Each of the pixels includes a driving unit, such as a thin film transistor. The upper substrate 3 is a color filter substrate that includes a color filter layer for implementing color in the liquid crystal display.

Pixel electrodes 9 are formed on the lower substrate 5 in FIG. 1. A common electrode 11 is formed on the upper substrate 3. Alignment layers 13 and 15 for aligning liquid crystal molecules in the liquid crystal layer 7 are respectively disposed on the pixel electrodes 9 and on the common electrode 11.

The lower substrate 5 and the upper substrate 3 are attached by a sealing material 17. Further, the sealing material 17 maintains and the liquid crystal layer 7 in between the lower substrate 5 and the upper substrate 3. The liquid crystal molecules of the liquid crystal layer 7 are driven by driving units (not shown) formed on the lower substrate 5. The pixel electrodes 9 are connected to driving units (not shown). The quantity of light transmitted through the liquid crystal layer 7 is controlled by voltages supplied by the driving units (not shown) and applied across the liquid crystal layer 7 using the pixel electrodes 9 so as to display information visually.

FIG. 2 is a flow chart of a method for fabricating a liquid crystal display device according to the related art. The fabrication process of the liquid crystal display device is roughly divided into a driving unit array substrate fabrication process for forming a driving unit on the lower substrate 5, a color filter substrate fabrication process for forming the color filter on the upper substrate 3, and a panel fabrication process. The panel fabrication process occurs after the color substrate fabrication process and the driving unit array substrate fabrication process.

As shown in FIG. 2, step S101 of the driving device array fabrication process includes forming a plurality of gate lines and a plurality of data lines on the lower substrate 5 to define a plurality of pixel areas, forming of thin film transistors in the driving areas, and forming driving devices that are connected to the gate lines and the data lines. In addition, the pixel electrodes 9, which are connected to the thin film transistors, are formed for driving a liquid crystal layer in response to a signal transmitted through the thin film transistor.

Step S104 of the color filter substrate fabrication process includes forming a color filter layer on the upper substrate. The color filter layer has R, G and B colors. A common electrode is then subsequently formed on the upper substrate.

Steps S102 and S105 of both driving unit array substrate fabrication process and the color filter substrate fabrication process include formation of alignment layers on the upper and lower substrates. The alignment layers are rubbed in a specific direction. The alignment layers provide an initial alignment and surface fixing force (i.e., pre-tilt angle and orientation direction) to the liquid crystal molecules of the liquid crystal layer formed between the upper and lower substrates.

Step S103 includes scattering a plurality of spacers onto the lower substrate for maintaining a uniform cell gap between the upper and lower substrates. Step S106 includes formation of a sealing material along an outer portion of the upper substrate. Thus, as described above, steps S101 to S106 depict the color substrate fabrication process and the driving unit array substrate fabrication process.

As shown in FIG. 2, step S107 of the panel fabrication process includes attaching the upper and lower substrates by compressing the upper and lower substrates together. Step S108 of the panel fabrication process includes dividing the attached upper and lower substrates into a plurality of individual liquid crystal panels. Step S109 of the panel fabrication process includes injecting the liquid crystal material into the liquid crystal panels through a liquid crystal injection hole, and then the liquid crystal injection hole is sealed to form the liquid crystal layer. Step S110 of the panel fabrication process includes testing the injected liquid crystal panel.

Operation of the LCD device makes use of an electro-optical effect of the liquid crystal material, wherein anisotropy of the liquid crystal material aligns liquid crystal molecules along a specific direction. Accordingly, control of the liquid crystal molecules significantly affects image stabilization of the LCD device. Thus, formation of the alignment layer is critical for fabricating an LCD device that produces quality images.

FIG. 3 is a schematic view of a method for forming an alignment layer using a roller coating method according to the related art. In FIG. 3, an alignment material 21 is uniformly supplied between an anylox roll 22 and a doctor roll 23 as the anylox roll 22 and the doctor roll 23 rotate. The alignment material 21 is provided using a dispenser 20 having an injector shape. Then, the alignment material 21 formed on a surface of the anylox roll 22 transfers onto a rubber plate 25 when the anylox roll 22 rotates while contacting a printing roll 24 upon which the rubber plate 25 is attached. A mask pattern is formed on the rubber plate 25 to selectively print the alignment layer on the substrate 26. The mask pattern of the rubber plate 25 is aligned with a substrate 26 upon which the alignment material 21 will be applied.

As a printing table 27, upon which the substrate 26 is loaded, is moved to contact the printing roll 24, the alignment material 21 is transferred onto the rubber plate 25 and is then subsequently transferred onto the substrate 26 to form an alignment layer. The thickness of the alignment layer is about 500 to 1000 Å (angstroms). However, a thickness variation of 100 Å in the alignment layer may generate a blot on the screen of the LCD device. Accordingly, an alignment layer having a uniform thickness is critical to display quality images on the screen of the LCD device.

The dispenser 20 supplies the alignment material 21 between an anylox roll 22 and a doctor roll 23 using a sweeping left-to-right motion along at an upper part of the anylox roll 22. As a result the dispensing in a sweeping left-to-right motion, the thickness of the resulting alignment layer may not be consistent. As a size of the substrate 26 increases, it becomes increasingly more different to form the alignment layer having a uniform thickness. For example, the thickness at the side edges of the alignment layer corresponding to the ends of the sweeping left-to-right motion is different than the middle of the alignment layer.

Since all of the alignment material 21 transferred on the rubber plate 25 is not necessarily transferred onto the substrate 26, a significant amount of the alignment material 21 is wasted as compared to the amount of alignment material 21 that was transferred onto the substrate 26. Accordingly, the amount of wasted alignment material 21 unnecessarily increases production costs. Further, a cleaning process must be periodically performed that complicates processing and degrades productivity. In addition, when the size of the substrate changes because of the need to produce another model, the roll (doctor roll, anylox roll, printing roll) must be replaced. Furthermore, as the substrate is enlarged in size, the size of the roll printing device (i.e., the anylox roll and the printing roll) is increased.

### SUMMARY OF THE INVENTION

Accordingly, the present invention is directed to an apparatus for forming an alignment layer of a liquid crystal display device and method for forming an alignment layer that substantially obviates one or more of the problems due to limitations and disadvantages of the related art.

An object of the present invention is to provide an apparatus for forming an alignment layer of a liquid crystal display device and a method for forming an alignment layer using the apparatus capable of forming an alignment layer with a uniform thickness across an entire surface of a substrate.

Another object of the present invention is to provide an apparatus for forming an alignment layer of a liquid crystal display device and a method for forming an alignment layer using the apparatus that prevents waste of alignment material.

Another object of the present invention is to provide an apparatus for forming an alignment layer of a liquid crystal display device and a method for forming an alignment layer that prevents generation of a defective alignment layer.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a method for forming an alignment layer of a liquid crystal display device includes: providing a substrate with a unit panel area; loading the substrate on a stage; selectively dropping an alignment material onto the unit panel area through an alignment material dropping unit having a head that has a plurality of holes through which the alignment material is dropped; and removing alignment material remaining about the holes of the alignment material dropping unit by an alignment material removing unit which scrapes the surface of the alignment material dropping unit having the holes therein.

In another aspect, an apparatus for forming an alignment layer of a liquid crystal display device includes: a stage to hold a substrate loaded thereon; an alignment material dropping unit having a head with a plurality of holes to drop an alignment material on the substrate; an alignment material supply unit to supply the alignment material to the alignment material dropping unit; and an alignment material removing unit to remove alignment material remaining about the holes.

In yet another aspect, An apparatus for forming an alignment layer of a liquid crystal display device includes: a stage for holding a substrate; an alignment material dropping means having holes for dropping an alignment material on the substrate; an alignment material supply means for supplying the alignment material to the alignment material dropping unit; and an alignment material removing means for removing alignment material remaining about the holes affixed to the stage.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a cross-sectional view of a related art liquid crystal display device.

FIG. 2 is a flow chart of a method for fabricating a related art liquid crystal display device.

FIG. 3 is a schematic view of a method for forming an alignment layer according to the related art.

FIG. 4 illustrates a first embodiment of the present invention.

FIG. 5 is a plan view showing the bottom of an alignment material dropping unit in accordance with the present invention.

FIG. 6A is a cross-sectional view illustrating alignment material remaining on the surface of the holes of the alignment material dropping unit.

FIG. 6B is a plan view illustrating alignment material remaining on the surface of the holes of the alignment material dropping unit.

FIG. 7 illustrates an apparatus for forming an alignment layer of a liquid crystal display device in accordance with a second embodiment of the present invention.

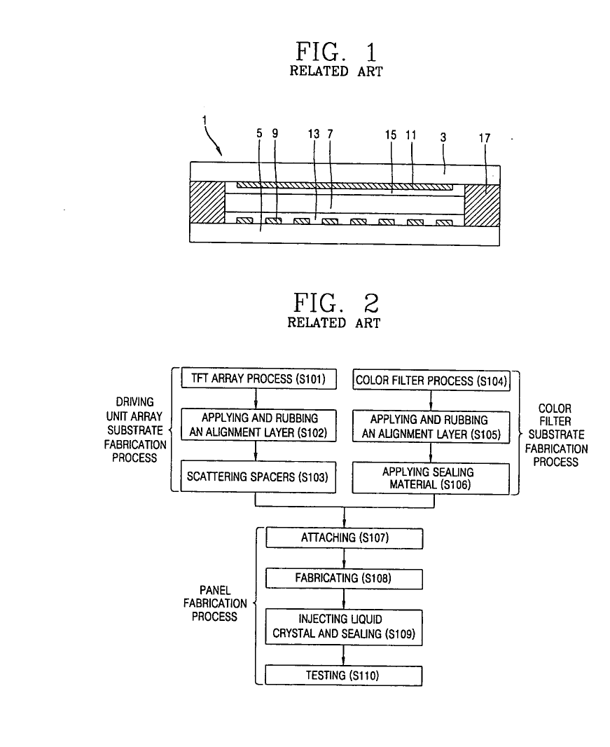

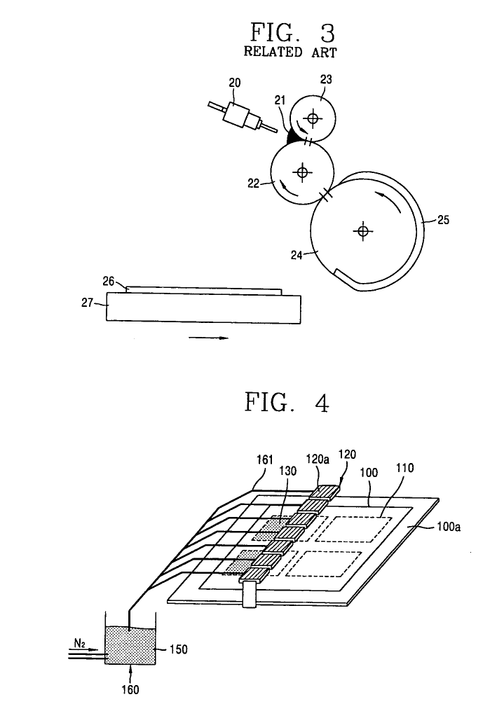

### DETAILED DESCRIPTION OF THE PREFERRED EMBODIMENTS

Reference will now be made in detail to the preferred embodiments of the present invention, examples of which are illustrated in the accompanying drawings.

FIG. 4 shows an alignment layer forming apparatus for forming an alignment layer of a liquid crystal display device in accordance with a first exemplary embodiment of the present invention. As shown in FIG. 4, the alignment layer forming apparatus includes an alignment material dropping unit 120 for dropping an alignment material on a substrate and a stage 100a on which the alignment material dropping unit 120 and a substrate 100 are loaded. After the substrate 100 is prepared, the substrate 100 is loaded on the stage, on which the alignment layer 130 is formed.

The substrate 100 is a mother substrate on which a plurality of substrates for a plurality of unit panels are disposed. For example, the substrates 110 of the mother substrate 100 can be thin film transistor array substrates or color filter substrates that respectively resulted from a thin film transistor array process and the color filter process.

In the thin film transistor array process, a first transparent substrate is prepared, and then, a plurality of gate lines and a plurality of data lines defining pixel areas are formed vertically and horizontally on the substrate. Subsequently, a driving device, such as a thin film transistor, is connected to the gate lines and the data lines in each pixel area. A passivation layer is formed over the thin film transistor and the entire pixel area, and then, a transparent pixel electrode is formed over the passivation layer.

In the color filter process, a second transparent substrate is prepared, and then, a black matrix is formed on the second transparent substrate. Subsequently, color filters are formed on the second transparent substrate corresponding to each of the pixel areas. Then, a common electrode is formed over the color filters and the black matrix.

The alignment layer forming apparatus in FIG. 4 is used to form an alignment layer 130 on the substrate 100. The alignment layer forming apparatus employs an ink-jet method and includes an alignment material dropping unit 120 for directly dropping an alignment material on the substrate 100, an alignment material supply unit 160 for supplying an alignment material 150 to the alignment material dropping unit 120, and an alignment material supply pipe 161 for mechanically connecting the alignment material dropping unit 120 and the alignment material supply unit 160. The alignment material supply pipe 161 also supplies the alignment material 150 to the alignment material dropping unit 120.

The alignment material dropping unit 120 includes a plurality of holes. A supply amount of the alignment material to be dropped on the substrate and a dropping position of the alignment material are controlled by opening and closing the holes. Further, the amount of alignment material to be dropped on the substrate is controlled by the size of the hole. In addition, an alignment layer process time can be controlled by controlling the number of holes.

When a nitrogen gas (N₂) is supplied to the alignment material supply unit 160 storing the alignment material 150, a pressure in the alignment material supply unit 160 is increased due to the nitrogen gas, and accordingly, the alignment material 150 is introduced into the alignment material dropping unit 120 through the alignment material supply pipe 161. At this time, the introduced alignment material is dropped on the substrate 100 through the holes formed in the alignment material-dropping unit 120, forming an alignment layer with a uniform thickness on the substrates 110.

Formation of a uniform alignment layer is made by moving the stage 100a on which the substrate 100 is positioned or the alignment material dropping unit 120, in concert with alignment material dropping from the alignment material-dropping unit 120. An alignment layer 130 is selectively formed on a region 110 of the mother substrate 100 where the alignment material dropping unit 120 has passed. In this case, the alignment layer 130 can be selectively formed by closing some holes in the alignment material dropping unit 120 when the alignment material dropping 120 is moved over the stage (not shown) to supply the alignment material 130a on the substrate 100. The alignment layer-formed area is substantially the area where either thin film transistor array substrates or color filter substrates have been formed.

The alignment material dropping unit 120 includes at least one head 120a having the plurality of holes with which a row of alignment material dropping areas 130 that were dropped by the head can be controlled, regardless of the length of the mother substrate. Of course, more heads can be added to accommodate other alignment material dropping areas 130, regardless of the length of the mother substrate. Furthermore, the width in a column direction of different rows alignment material dropping areas 130 can be different sizes.

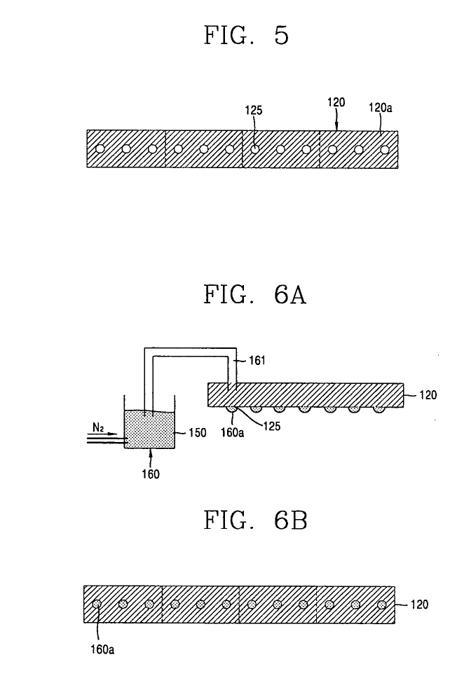

FIG. 5 is a plan view of the bottom of the alignment material dropping unit 120. As shown in FIG. 5, the alignment material dropping unit 120 includes the plurality of heads 120a arranged in column direction. Each head 120a includes a plurality of holes 125 isolated at regular intervals d1. The alignment material is dropped on the substrate through the holes 125. Accordingly, by controlling the size of the hole 125 and the isolation interval d1 between holes 125, the thickness of the alignment layer and uniformity of the thickness of the alignment layer formed on the substrates 110 can be controlled. In addition, since each hole 125 can be opened and closed, even for a multi-model glass having two or more substrate models, the alignment layer can be easily formed by selectively opening and closing the holes.

As mentioned above, the alignment layer forming apparatus using the ink-jet method can easily cope with the various substrate models and a large substrate. Since the necessary amount of alignment material can be dropped directly on the substrate, consumption of the alignment material can be minimized so that fabrication cost of the liquid crystal display device can be considerably reduced. However, after dropping the alignment material, the alignment material may remain about the surface of the holes. If the alignment material is allowed to harden about the holes, the holes may become clogged. Clogged holes prevent the accurate drop of alignment material at a desired position. In other words, a defective alignment will result if alignment material is not properly supplied to the substrates due to clogged holes.

FIG. 6A is a cross-sectional view and FIG. 6B is a plan view illustrating alignment material remaining on the surface of the holes of the alignment material dropping unit. As illustrated in FIGS. 6A and 6B, the alignment material 160a remains about the holes 125 of the alignment material dropping unit 120. This is a result of the viscosity of the alignment material. Namely, after the alignment material is dropped on the substrate through the holes 125, some of the alignment material remains about the holes 125. As mentioned above, the alignment material 160a remaining about the holes 125 hardens over time to cause the holes 125, through which the alignment material is discharged, become clogged. When the hole 125s are clogged, the alignment layer cannot be normally formed. Thus, for the purposes of smooth and consistent supply of alignment material, the alignment material 160a clogging the holes 125 is removed.

The alignment material 160a remaining about the holes 125 can be removed using a wiper. In other words, the alignment material remaining about the hole is rubbed away with the wiper, and then the hole is rinsed out with a cleaning solution, such as NMP or IPA, thereby removing the alignment material remaining in the holes 125. This operation is manually performed by an operator when the alignment material is replaced. However, with this method of using the wiper, there is a limit to how much of the hardened alignment material in the hole and on the surface of the hole can be removed.

A second embodiment of the present invention includes an alignment material removing unit that is provided adjacent the alignment material dropping unit. By placing an alignment material removing unit adjacent to the alignment material dropping unit, an alignment material remaining on the surface of the alignment material dropping unit can be completely removed before any hardening of the alignment material occurs, thereby preventing clogging of the hole due to a possible remaining alignment material even without performing an alignment material removing operation. In other words, a drop of aligning material hang at the edge of a hole can be quickly wiped away to leave an unobstructed hole clear of any residual aligning material.

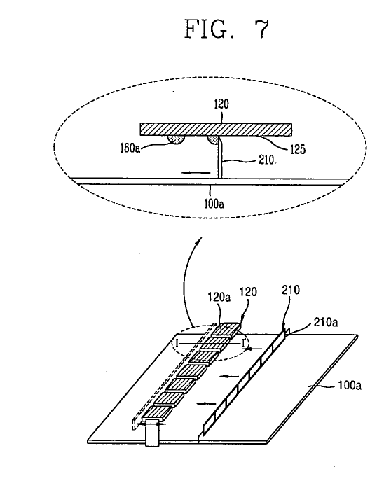

FIG. 7 illustrates an apparatus for forming an alignment layer of a liquid crystal display device in accordance with a second embodiment of the present invention, in which all the elements except for an alignment material removing unit 210 are the same as in FIGS. 6A and 6B, and the same reference numerals are given to the same elements. As illustrated in FIG. 7, formation of an alignment layer in accordance with the second embodiment of the present invention includes an alignment material removing using an alignment material removing unit 210. The alignment material removing unit 210 can be affixed to a stage.

In the alignment material moving step, the alignment material removing unit 210 is moved so as to scrape the surface of the alignment material dropping unit 120 having the holes, thereby removing the alignment material remaining at the surface of the hole. The alignment material removing unit 210 can be affixed to the stage 100a so that the residual alignment material is removed by movement of the stage 100a. In the alternative, the alignment material removing unit 210 can be moved under the alignment material dropping unit 120 so that the residual alignment material is removed by movement of the alignment material removing unit 210.

As shown in the enlarged sectional view of I-I′, the alignment material removing unit 210 scrapes the entire surface of the alignment material dropping unit 120 having the holes 125 formed therein to remove the alignment material 160a remaining at the edges of or about the holes 125. Thus, the alignment material removing unit 210 can be formed in any shape as long as it has a certain length that can contact the surface of the alignment material dropping unit 120 having the holes 125 across at least one of the holes. To remove the residual alignment material by a one-time scraping, the alignment material removing unit 210 needs to be wide enough to scrape across all of the holes 125 formed in the alignment material dropping unit 120.

Since the alignment material dropping unit 120 includes a plurality of heads 120a, the width of alignment material removing unit 210 needs to be commensurate with the number of heads 120a. Thus, the alignment material removing unit 210 includes a plurality of units 210a to cope with the number of the alignment material dropping heads 120a. For example, each unit 210a is disposed to correspond to a head 120a of the alignment material dropping unit.

After the alignment material is dropped, the alignment material remaining on the surface of the alignment material dropping unit about the hole is removed using the alignment material removing unit before it hardens so that the alignment material remaining on the surface about holes can be completely and effectively removed. Therefore, an operator does not have to rub or scrape the surface about the holes with the alignment removing wiper and rinse it.

As mentioned above, exemplary embodiments of the present invention provide the apparatus for forming an alignment layer of a liquid crystal display device and the method for forming an alignment layer using the apparatus. In particular, exemplary embodiments of the present invention are directed to formation of a uniform alignment layer using the alignment layer forming apparatus including an ink-jet head having a plurality of holes. The alignment layer forming method through the ink-jet system can cope with a large substrate by controlling the number of heads of the alignment material dropping unit. Such an alignment layer forming process is simple as compared to the related art, thereby enhancing fabrication efficiency. That is, in the related art, since the alignment layer is formed using the roll printing method, a lot of alignment material is wasted. Further, as the substrate is enlarged in the related art, it is difficult to form a uniform alignment layer across the entire surface of the substrate.

Comparatively, in exemplary embodiments of the present invention, the necessary amount of alignment material can be dropped at the region where an alignment layer is to be formed so that the alignment material is not wasted. Thus, the fabrication cost can be reduced and a uniform alignment layer can be formed on a large substrate. In addition, after the alignment material is dropped, the alignment material remaining on the surface about the hole can be effectively removed using an alignment material removing unit prior to the alignment material hardening, thereby preventing the clogging of the holes. By providing the alignment material removing unit for removing an alignment material remaining for the alignment material dropping unit, a defect occurrence rate of the alignment layer can be reduced, so that process time is reduced and productivity can be enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for forming an alignment layer of a liquid crystal display device comprising:
providing a substrate with a unit panel area;
loading the substrate on a stage;
selectively dropping an alignment material onto the unit panel area through an alignment material dropping unit having a head that has a plurality of holes through which the alignment material is dropped; and
removing alignment material remaining about the holes of the alignment material dropping unit by an alignment material removing unit which scrapes the surface of the alignment material dropping unit having the holes therein.

2. The method of claim 1, wherein the alignment material dropping unit has a plurality of heads that each has a plurality of holes.

3. The method of claim 1, wherein the stage is moved in concert with the dropping of the alignment material.

4. The method of claim 1, wherein the alignment material dropping unit is moved in concert with the dropping of the alignment material.

5. The method of claim 1, wherein the step of removing alignment material remaining about the holes includes moving the alignment material dropping unit so that alignment material remaining on the surface of the hole is removed.

6. The method of claim 1, wherein the step of removing alignment material remaining about the holes includes moving alignment material removing unit so that alignment material remaining on the surface of the hole is removed.

7. The method of claim 1, wherein the amount of alignment material to be dropped on the substrate is controlled by opening and closing of the hole.

8. The method of claim 1, wherein the amount of alignment material to be dropped on the substrate is controlled according to the size of the hole.

9. An apparatus for forming an alignment layer of a liquid crystal display device comprising:
a stage to hold a substrate loaded thereon;
an alignment material dropping unit having a head with a plurality of holes to drop an alignment material on the substrate;
an alignment material supply unit to supply the alignment material to the alignment material dropping unit; and
an alignment material removing unit to remove alignment material remaining about the holes.

10. The apparatus of claim 9, wherein the alignment material dropping unit has a plurality of heads that each has a plurality of holes.

11. The apparatus of claim 9, wherein the alignment material removing unit has the same width as a width of the alignment material dropping unit.

12. The apparatus of claim 9, wherein the alignment material removing unit includes a plurality of units and can be changed in its width depending on a width of the alignment material dropping unit.

13. The apparatus of claim 12, wherein the alignment material dropping unit has a plurality of heads that each has a plurality of holes and a single unit of the alignment material removing unit corresponds to a single head of the alignment material dropping unit.

14. The apparatus of claim 9, wherein the alignment material dropping unit is affixed to the stage.

15. An apparatus for forming an alignment layer of a liquid crystal display device comprising:
a stage for holding a substrate;
an alignment material dropping means having holes for dropping an alignment material on the substrate;
an alignment material supply means for supplying the alignment material to the alignment material dropping unit; and
an alignment material removing means for removing alignment material remaining about the holes affixed to the stage.

16. The apparatus of claim 15, wherein the alignment material dropping means has a plurality of heads that each has a plurality of holes.

17. The apparatus of claim 15, wherein the alignment material removing means has the same width as a width of the alignment material dropping means.

18. The apparatus of claim 15, wherein the alignment material removing means includes a plurality of units and can be changed in its width depending on a width of the alignment material dropping means.

19. The apparatus of claim 18, wherein the alignment material dropping means has a plurality of heads that each has a plurality of holes and a single unit of the alignment material removing means corresponds to a single head of the alignment material dropping means.
